(19) United States
(12) Patent Application Publication
(10) Pub. No.: US 2012/0159318 A1
(43) Pub. Date: Jun. 21, 2012

(54) FULL SCREEN VIEW READING AND EDITING USER INTERFACE

(75) Inventors: Han-Yi Shaw, Redmond, WA (US); Brian T. Kelley, Bellevue, WA (US)

(73) Assignee: MICROSOFT CORPORATION, Redmond, WA (US)

(21) Appl. No.: 12/969,468

(22) Filed: Dec. 15, 2010

(51) Int. Cl. G06F 17/20

(52) U.S. Cl. 715/273

(57) ABSTRACT

An improved full screen view user interface is provided that presents a user interface-light reading mode for reading a document, and a user interface-light editing mode for editing or authoring a document. A full screen view reading mode provides a full page reading environment that simulates real world effects, such as page curls, to enhance a reading experience that is intended to be focused on the task of reading a document. A full screen editing mode provides a full page editing environment that, upon demand, reveals selectable controls that are relevant to editing or authoring a document to provide a simplified, non-distracting writing environment.

### BACKGROUND

Computer and software users have grown accustomed to user-friendly software applications that help them write, calculate, organize, prepare presentations, send and receive electronic mail, make music, and the like. For example, modern electronic word processing applications allow users to view, prepare, and edit a variety of documents.

To assist with the utilization of functionality of a given software application, a user interface containing a plurality of generic functionality controls is typically provided along an upper, lower, or side edge of a displayed workspace in which the user may view, enter, copy, manipulate, and format text or data. There may be times when users may not need to use some functionality controls, but the user interface may contain extraneous information that crowds the display area. For example, a user may be creating a word processing document, but may only need to use certain basic functionality controls. He/she may wish to be presented with a simplified functionality control menu, rather than a highly inclusive toolbar. Alternatively, sometimes a user may launch a software application, for example, a word processing application, to read a document, but the user may not desire to enter or edit data. In this case, the user may not need to use any functionality controls, and may wish to have more screen display area for viewing the document.

It is with respect to these and other considerations the present invention has been made.

### SUMMARY

Embodiments of the present invention solve the above and other problems by providing an improved user interface for displaying a full screen view optimized for reading a document and optimized for editing a document. According to embodiments of the invention, a full screen view reading mode provides a view optimized for reading, as opposed to authoring a document. A user may be presented with simulated real world effects, such as page curls, to enhance a reading experience that is intended to be focused on the reading of a document. A full screen view editing mode provides a user an interface-light, but full-fledged editing mode. Editing mode may be optimized for editing or authoring a document in a full screen view wherein controls that are relevant to editing or authoring tasks may be provided on demand to provide a user interface-light, aesthetically-pleasing, and non-distracting display.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1 is an illustration of an in-window view switcher control, an entry point for full screen view option.

FIG. 2 is an illustration of a document displayed in full screen view editing mode.

FIG. 3 is an illustration of a full screen view editing mode user interface toolbar.

FIG. 4 is an illustration of a full screen view reading mode user interface toolbar.

FIG. 5 is an illustration of a full screen view search/find user interface toolbar.

FIG. 6 is a simplified block diagram of a system including a computing device with which embodiments of the invention may be practiced.

### DETAILED DESCRIPTION

As briefly described above, embodiments of the present invention are directed to providing an improved user interface for displaying a full screen view user interface optimized for reading a document and optimized for editing a document.

In today's computer age, applications, such as word processing or spreadsheet applications, are used extensively by a range of users. As mentioned previously, users have grown accustomed to user-friendly applications, and have come to expect a user interface that provides various functionality controls for allowing the user to enter, manipulate, and/or format text or data as is needed. As technology advances and as more options and functionalities are provided for users to utilize, user interfaces of various applications may consume more display space than before. Some users may prefer less displayed functionality controls. For example, some users may prefer to utilize various shortcut keys instead of functionality controls displayed in a user interface. Other users may utilize applications more so to view a document than to enter or manipulate text or data. Other users may utilize a given application to enter data or text, but may only need basic functionality controls rather than a large selection of editing and formatting controls. For such cases and others, embodiments of the present invention provide for a more focused, full screen, user interface-light view.

According to embodiments, a full screen view may be optimized for writing/editing or for reading a document. A full screen view editing mode is intended to be a user interface-light, but full-fledged editing mode. Basic functionality controls may be provided in a transient full screen view editing mode toolbar. A full screen view reading mode is optimized for reading, as opposed to authoring. A user interface may be provided for page navigation, margin display, and for searching.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

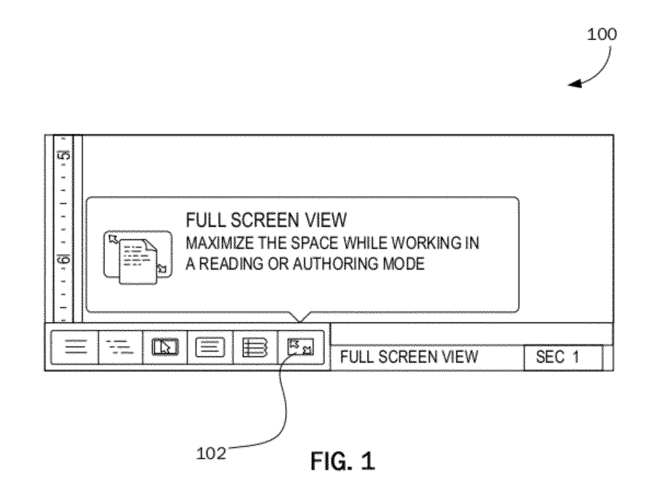

According to embodiments, a user may enter full screen view by a selection of a user interface entry point, such as a selectable full screen view option provided in a view menu or via a selection of an in-window view switcher control 102 as illustrated in FIG. 1. According to embodiments, the full screen view setting may be a temporary state that may not be preserved when a document is saved.

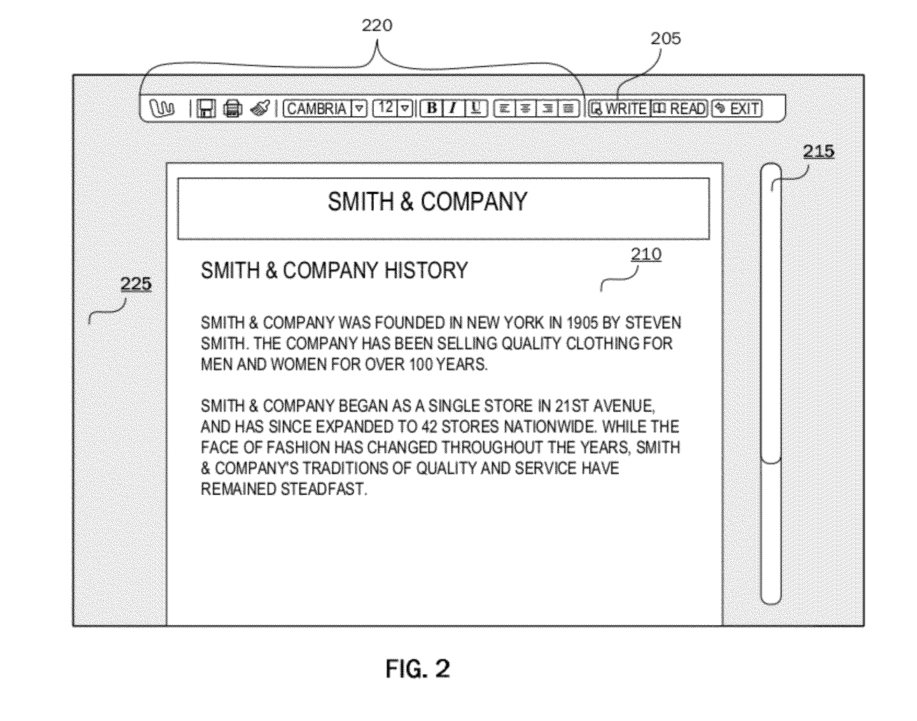

FIG. 2 is an illustration of a computer screen display showing a full screen view editing mode user interface toolbar 220 for displaying top-level functionality controls relevant to and associated with writing or editing a document. As briefly described above, a full screen view editing mode is intended to be a user interface-light, but full-fledged editing mode. A document 210, such as a word processing document, may be displayed in a full screen view. A “Write” selectable functionality control 205 may be provided. According to embodiments of the present invention, upon receiving a command for displaying a document 210 in a full screen view user interface in an editing mode, a lightweight editing mode toolbar 220 containing one or more selectable functionality controls for applying one or more associated functions of a software application to the displayed document may be displayed. The editing mode toolbar 220 may be provided with a variety of background colors, for example and as shown in FIG. 2, black. Additionally, the toolbar 220 may be translucent. The editing mode toolbar 220 may be lightweight. That is, the editing mode toolbar 220 may contain one or more selectable functionality controls for applying a most frequently used subset of a plurality of functions available from a software application.

When full screen view is initiated, the editing mode toolbar 220 may be displayed along an edge of the display. After an elapse of a prescribed amount of time (e.g., 3-4 seconds), the editing mode toolbar 220 display may be removed from the full screen view user interface to provide additional display space for viewing a displayed document 210. According to embodiments, a full screen view editing toolbar 220 may be removed from the full screen view user interface via a display animation effect. Various animation effects may be incorporated including, but not limited to, slide-out, fade-out, disappear, dissolve, or any other animation effect known in the art.

Upon receiving an indication of a focus of a cursor in a specified area of the full screen view user interface, the display of the lightweight editing mode toolbar 220 may be restored. According to embodiments, a full screen view editing toolbar 220 may be restored to the full screen view user interface via a display animation effect. The animation effect may be one of various animation effects known in the art. Consider as an example, a user may decide to edit a document 210 in full screen view editing mode. He/she may select a full screen view switcher control 102 provided in a user interface. Upon detection of the selection, the document 210 may be displayed in full screen view editing mode, and a full screen view editing mode toolbar 220 may be displayed along a top edge of the display as shown in FIG. 2. After a prescribed amount of time (e.g., 3-4 seconds), the toolbar 220 may be removed from the display via an animation effect. For example, the toolbar 220 may ascend and slide out from the user interface. While editing the document 210, the user may decide to utilize a functionality control of the software application, for example, boldface. The user may move his/her cursor to the top edge of the user interface where the full screen view editing toolbar 220 was previously displayed, and consequently, the display of the toolbar 220 may be restored. A display animation effect may be utilized, for example, the toolbar may descend and slide in from the top edge of the user interface display. The functionality controls may then be displayed, and the user may select the boldface functionality control.

As illustrated in FIG. 2, a scroll bar 215 may be provided along a side edge of the display. The scroll bar 215 may be positioned so that it is easily accessible, but not along the edge of the document 210 so that it may be distracting or in the user's way. A background 225 of full screen view may be displayed behind a document 210. According to embodiments, the background 225 may be a contrasting background for enhancing readability of a displayed document 210. The background 225 may be matte black by default, and various other selectable backgrounds may be provided to provide a non-distracting backdrop for a user to focus on a displayed document 210. The various other selectable backgrounds may include various background colors or various wood types and grains to provide an effect of a paper lying on a desk.

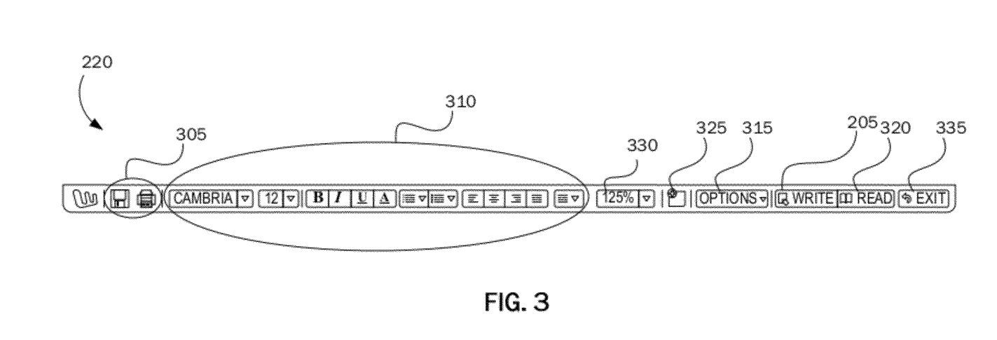

Referring now to FIG. 3, an illustration of a user interface toolbar 220 for displaying selectable controls associated with writing or editing a document 210 is shown. As described above, the user interface toolbar 220 may be displayed according to a variety of colors (e.g., black), may be translucent, and may contain a most frequently used subset of a plurality of selectable functionality controls associated with writing or editing a document 210. For example, and as shown in FIG. 3, an editing mode user interface toolbar 220 may include selectable controls for general file commands 305 such as file save and print. An editing mode user interface toolbar 220 may include selectable functionality controls for general formatting commands 310 such as text type, font size, line spacing, boldface, italics, underline, text justification, bullets, and numbering.

Other selectable functionality controls may be provided in the editing mode user interface toolbar 220, such as a “zoom” functionality control 330 and an “add comment” functionality control 325. An “options” functionality control 315 may be provided, which, when selected, may provide a menu of various selectable options that are not included in the main editing mode user interface toolbar 220. For example, an options menu in editing mode may include such functionalities as find, track changes, show comments and changes, show original/final document, and background options. An “exit” functionality control 335 may be provided in an editing mode user interface toolbar 220, which, when selected, may exit reading mode, and may restore an original view of a document 310. The page that was being viewed upon exiting reading mode may be preserved when the original view is restored. An editing mode user interface toolbar 220 may also include a “write” selectable functionality control 205 and a “read” selectable functionality control 320. Upon selection of a “write” 205 or “read” 320 selectable functionality control, the full screen view may toggle to the selected mode (reading or editing mode). As should be appreciated, the selectable functionality controls included in the editing mode user interface toolbar 220 may be modified according to individual user preferences.

As was briefly described above, a full screen view reading mode may provide a view optimized for reading, as opposed to, writing or editing a document 210. According to an embodiment, a document 210 being viewed in reading mode may not be able to be edited. Selectable functionality controls may be provided in a reading mode user interface toolbar for allowing such functionalities as page navigation, margin display, and search. In full screen view reading mode, a page of a document 210 may be displayed in its entirety (e.g., like a physical sheet of paper).

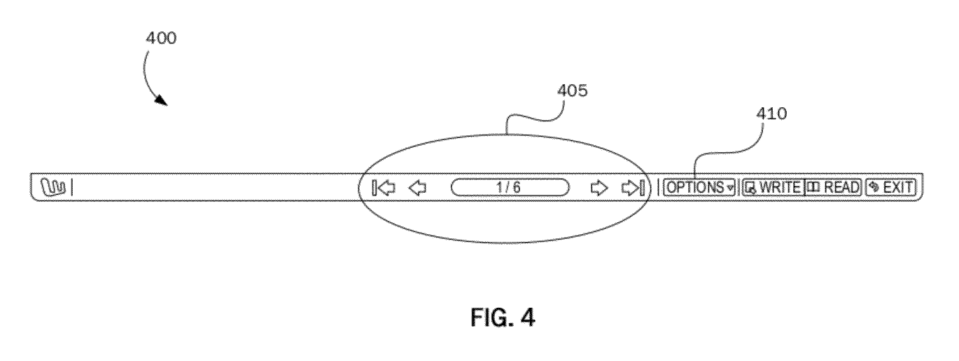

Referring now to FIG. 4, an illustration of a user interface toolbar 400 for displaying selectable controls associated with reading a document 210 is shown. Like a full screen view editing mode user interface toolbar 220, the lightweight reading mode user interface toolbar 400 may be displayed according to a variety of colors (e.g., black), may be translucent, and may contain basic or most frequently used subset of a plurality of functions available from a software application associated with reading a document 210. According to an embodiment, the full screen view reading mode user interface toolbar 400 may be hidden from view. The reading mode UI toolbar 400 may be presented upon entering full screen view editing mode and when a user focuses a cursor in a specified area of the full screen view user interface for a prescribed amount of time. For example, if a user moves the cursor to the top of a display screen (e.g., within a 40 pixel area counting downward from the top edge of the screen) for one second, the reading mode UI toolbar 400 may slide into view from the top edge of the screen. Upon selection of a functionality control or after a prescribed amount of time, the reading mode UI toolbar 400 may be hidden from view. As shown in FIG. 4, a reading mode user interface toolbar 400 may include selectable controls for page navigation 405. An “options” functionality control 410 may be included to provide a user with additional functionalities. Upon selection of the “options” functionality control 410, an options menu dropdown may be displayed, which may include a “find” functionality, “margin setting” functionality, and a “page flip effect” functionality. As should be appreciated, the selectable functionality controls included in the reading mode user interface toolbar 400 may be modified according to individual user preferences.

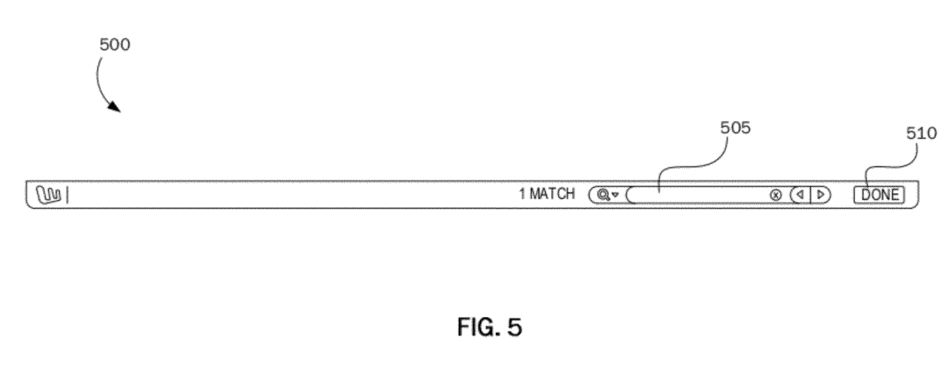

Upon selection of a “find” functionality, the reading mode user interface toolbar 400 may be removed from the display and may be replaced by a find or search toolbar like the find toolbar shown in FIG. 5. The reading mode user interface toolbar 400 may be removed from the display via one of various display animation effects, such as a slide-out animation. By replacing the reading mode user interface toolbar 400 with a find toolbar 500, screen display space is maximized for viewing a document 210. A user may enter text for which to search in a search field 505 within the find toolbar 500. After a search is completed, or when a user wants to return to the reading mode user interface toolbar 400, he/she may select a “done” functionality control 510. Referring back to FIG. 4, a user may be able to show or suppress page margins by selecting “show margins” or “suppress margins” after selecting a “margin setting” functionality control from the options menu dropdown.

Embodiments of the present invention provide for a full page reading environment that provides a display of one or more simulated page movement visual effects via an animation function of the software application. For example, the full page reading environment simulates real world effects, such as a page flip effect, to enhance a user's reading experience. Various page flip effect options may be provided to a user from which to choose. For example, a user may choose a “fly through” option. According to a fly through option, a first page may be displayed. Upon selection to “flip” to another page, the first page may appear to move to the forefront of the display, then fade out, and become replaced with the other page. As another example, a user may choose a “page curl” option to transition from one page to another. The page curl effect may simulate a page slowly turning. As the page turns, a user may see the back of the image mapped to the opposite side of the curl. A user may also choose to turn off the page flip effect.

As described above, embodiments of the present invention may provide for an improved user interface for displaying a full screen view. The full screen view reading mode may provide an optimized user interface for reading a document, and a full screen view editing mode may provide an optimized user interface for editing a document. Both the full screen view reading and editing modes provide a user with an interface-light, aesthetically-pleasing, and non-distracting display.

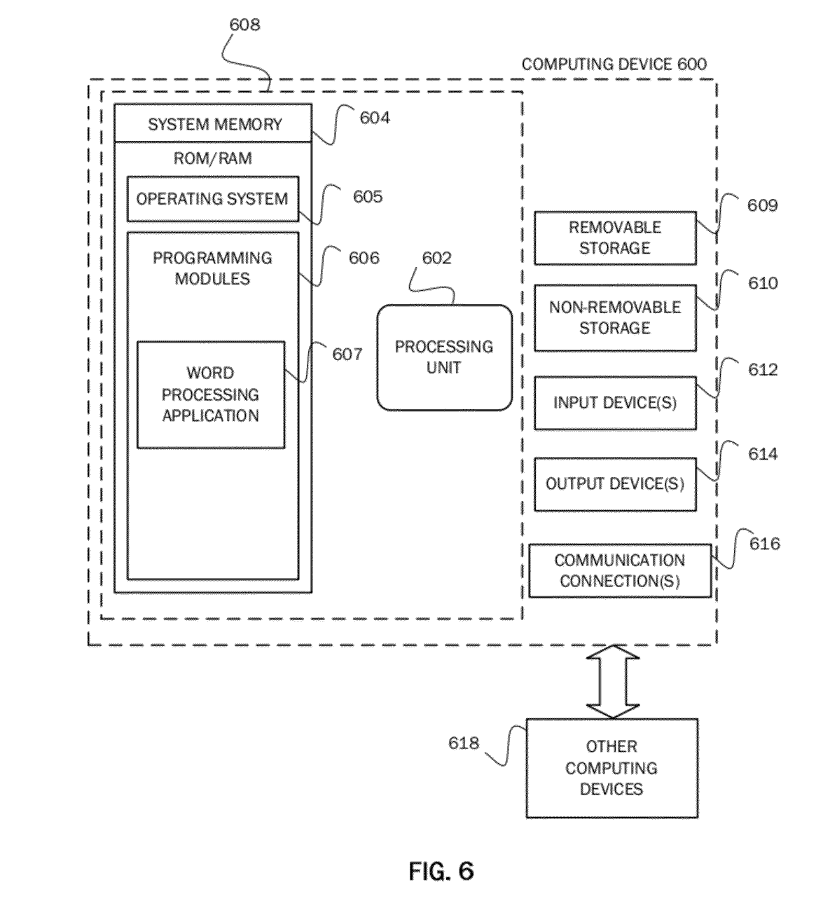

Embodiments of the invention as described above may be implemented via local and remote computing and data storage systems, including the systems illustrated and described with reference to FIG. 6. Consistent with embodiments of the invention, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any other computing devices 618, in combination with computing device 600, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention.

With reference to FIG. 6, a system consistent with embodiments of the invention may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a word processing application 607, wherein the word processing application is a software application having sufficient computer-executable instructions, which when executed, performs functionalities as described herein. Operating system 605, for example, may be suitable for controlling computing device 600's operation. Furthermore, embodiments of the invention may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computing device 600 may also contain a communication connection 616 that may allow device 600 to communicate with other computing devices 618, such as over a network in a distributed computing environment, for example, an intranet or the Internet. Communication connection 616 is one example of communication media.

As stated above, a number of program modules and data files may be stored in system memory 604, including operating system 605. While executing on processing unit 602, programming modules 606 may include the word processing application 607, wherein the word processing application may contain sufficient computer-executable instructions, which when executed, perform functionalities as described herein. The aforementioned process is an example, and processing unit 602 may perform other processes. Other programming modules that may be used in accordance with embodiments of the present invention may include electronic mail and contacts applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing editing functionality in a full screen view user interface, the method comprising:
receiving a command via a software application for displaying a document;
receiving a command via the software application for displaying the document in a full screen view user interface in an editing mode, the editing mode for allowing edits to the displayed document via one or more functions of the software application;
displaying in the full screen view user interface a lightweight editing mode toolbar containing one or more selectable functionality controls for applying one or more associated functions of the software application to the displayed document;
after an elapse of a prescribed amount of time, removing the display of the lightweight editing mode toolbar from the full screen view user interface to provide additional display space in the full screen view user interface for viewing the displayed document; and
upon receiving an indication of a focus of a cursor in a specified area of the full screen view user interface, restoring the display of the lightweight editing mode toolbar in the full screen view user interface.

2. The method of claim 1, when displaying the document in a full screen view user interface in an editing mode, further comprising displaying a contrasting background behind the displayed document for enhancing readability of the displayed document.

3. The method of claim 2, wherein displaying a contrasting background behind the displayed document for enhancing readability of the displayed document includes displaying the contrasting background according to one or more background colors.

4. The method of claim 1, wherein receiving a command via the software application for displaying the document in a full screen view user interface in an editing mode includes receiving a selection of a selectable control provided by the software application for displaying the document in a full screen view user interface in an editing mode.

5. The method of claim 1, wherein removing the display of the lightweight editing mode toolbar from the full screen view user interface to provide additional display space in the full screen view user interface for viewing the displayed document includes removing the display of the lightweight editing mode toolbar via a display animation.

6. The method of claim 5,
wherein removing the display of the lightweight editing mode toolbar via a display animation includes sliding the display of the lightweight editing mode toolbar off a side of the full screen view user interface until the lightweight editing mode toolbar is no longer in view; and
wherein restoring the display of the lightweight editing mode toolbar in the full screen view user interface includes sliding the display of the lightweight editing mode toolbar onto the full screen view user interface from a same side from which the lightweight editing mode toolbar was removed from display until the lightweight editing mode toolbar is in view.

7. The method of claim 5,
wherein removing the display of the lightweight editing mode toolbar via a display animation includes sliding the display of the lightweight editing mode toolbar off an upper edge of the full screen view user interface until the lightweight editing mode toolbar is no longer in view; and
wherein restoring the display of the lightweight editing mode toolbar in the full screen view user interface includes sliding the display of the lightweight editing mode toolbar onto the full screen view user interface from a same upper edge from which the lightweight editing mode toolbar was removed from display until the lightweight editing mode toolbar is in view.

8. The method of claim 5,
wherein removing the display of the lightweight editing mode toolbar via a display animation includes fading out the display of the lightweight editing mode toolbar until the lightweight editing mode toolbar is no longer in view; and
wherein restoring the display of the lightweight editing mode toolbar in the full screen view user interface includes fading in the display of the lightweight editing mode toolbar until the lightweight editing mode toolbar is in view.

9. The method of claim 1, wherein displaying in the full screen view user interface a lightweight editing mode toolbar containing one or more selectable functionality controls for applying one or more associated functions of the software application to the displayed document includes displaying in the lightweight editing mode toolbar one or more selectable functionality controls for applying a most frequently used subset of a plurality of functions available from the software application.

10. The method of claim 9, wherein displaying in the lightweight editing mode toolbar one or more selectable functionality controls for applying a most frequently used subset of a plurality of functions available from the software application includes displaying one or more of selectable controls for saving a document, printing a document, general formatting function controls, including text type, font size, line spacing, boldface, italics, underline, text justification, bullets, and numbering, a zoom function control, an add comment function control, and an options functionality control which when selected may provide a menu of various selectable options that are not initially included in the lightweight editing mode toolbar.

11. The method of claim 1, further comprising upon receiving a selection of a find function control from the lightweight editing mode toolbar, replacing the one or more selectable functionality controls contained in the lightweight editing mode toolbar with a find function user interface component for allowing a search for information contained in the displayed document.

12. A method for providing reading functionality in a full screen view user interface, the method comprising:
receiving a command via a software application for displaying a document;
receiving a command via the software application for displaying the document in a full screen view user interface in a reading mode, the reading mode for allowing an optimized view of the displayed document;
displaying in the full screen view user interface a lightweight reading mode toolbar containing one or more selectable functionality controls for navigating through the displayed document;
after an elapse of a prescribed amount of time, removing the display of the lightweight reading mode toolbar from the full screen view user interface to provide additional display space in the full screen view user interface for viewing the displayed document; and
upon receiving an indication of a focus of a cursor in a specified area of the full screen view user interface, restoring the display of the lightweight reading mode toolbar in the full screen view user interface.

13. The method of claim 12, when displaying the document in a full screen view user interface in a reading mode, further comprising displaying a contrasting background behind the displayed document for enhancing readability of the displayed document.

14. The method of claim 13, wherein displaying a contrasting background behind the displayed document for enhancing readability of the displayed document includes displaying the contrasting background according to one or more background colors.

15. The method of claim 12,
wherein removing the display of the lightweight reading mode toolbar from the full screen view user interface to provide additional display space in the full screen view user interface for viewing the displayed document includes sliding the display of the lightweight reading mode toolbar off a side of the full screen view user interface via a user interface animation until the lightweight reading mode toolbar is no longer in view; and
wherein restoring the display of the lightweight reading mode toolbar in the full screen view user interface includes sliding the display of the lightweight reading mode toolbar onto the full screen view user interface from a same side from which the lightweight reading mode toolbar was removed from display until the lightweight reading mode toolbar is in view.

16. The method of claim 12,
wherein removing the display of the lightweight reading mode toolbar from the full screen view user interface to provide additional display space in the full screen view user interface for viewing the displayed document includes sliding the display of the lightweight reading mode toolbar off an upper edge of the full screen view user interface until the lightweight reading mode toolbar is no longer in view; and
wherein restoring the display of the lightweight reading mode toolbar in the full screen view user interface includes sliding the display of the lightweight reading mode toolbar onto the full screen view user interface from a same upper edge from which the lightweight reading mode toolbar was removed from display until the lightweight reading mode toolbar is in view.

17. The method of claim 12,
wherein removing the display of the lightweight reading mode toolbar from the full screen view user interface to provide additional display space in the full screen view user interface for viewing the displayed document includes fading out the display of the lightweight reading mode toolbar until the lightweight reading mode toolbar is no longer in view; and
wherein restoring the display of the lightweight reading mode toolbar in the full screen view user interface includes fading in the display of the lightweight reading mode toolbar until the lightweight reading mode toolbar is in view.

18. The method of claim 12, further comprising upon receiving a selection of a find function control from the lightweight reading mode toolbar, replacing the one or more selectable functionality controls for navigating through the displayed document with a find function user interface component for allowing a search for information contained in the displayed document.

19. The method of claim 12, wherein upon receiving a selection of a functionality control associated with a page turning function of the software application, providing a display of one or more simulated page movement visual effects via an animation function of the software application.

20. A computer readable medium containing computer-executable instructions which when executed by a computer perform a method for providing editing functionality in a full screen view user interface, the method comprising:
receiving a command via a software application for displaying a document;
receiving a command via the software application for displaying the document in a full screen view user interface for allowing edits to and reading of the displayed document via one or more functions of the software application;
displaying in the full screen view user interface a lightweight toolbar containing one or more selectable functionality controls for controlling the displayed document;
after an elapse of a prescribed amount of time, removing the display of the lightweight toolbar from the full screen view user interface to provide additional display space in the full screen view user interface for viewing the displayed document; and
upon receiving an indication of a focus of a cursor in a specified area of the full screen view user interface, restoring the display of the lightweight toolbar in the full screen view user interface.
